(19) United States
(12) Patent Application Publication
(10) Pub. No.: US 2026/0359822 A1
(43) Pub. Date: Nov. 12, 2026

(54) GYROSCOPIC CHIP FOR FRAUD PREVENTION

(71) Applicant: Bank of America Corporation, Charlotte, NC (US)

(72) Inventors: Kiran Pulla, Hyderabad (IN); Anantharajan Srinivasarangan, Tamil Nadu (IN); Chinmay Barhale, Hyderabad (IN); Sam Christian, Secunderabad (IN); Bharathi Venkatesh, Tamil Nadu (IN); Padmini Chamarti, Hyderabad (IN)

(21) Appl. No.: 19/199,667

(22) Filed: May 6, 2025

(51) Int. Cl. G06Q 20/40

(52) U.S. Cl. CPC G06Q 20/4016; G06Q 20/4015

(57) ABSTRACT

Apparatus, methods and systems for tracking and monitoring customer transactions. Methods may include capturing data relating to rotational motion of a payment device and data relating to an elevation level of the payment device. Methods may include generating a baseline movement profile for a user of the payment device that comprises movement patterns of the user identified from historical transactions. In response to determining that the rotational motion and the movement patterns differ, methods may include terminating the transaction and transmitting a fraud alert to the user. Methods may include determining an address and a floor at which the transaction was initiated. Methods may include requesting, from the user, confirmation that the determined address and the floor matches an address and floor at which the user is located. In response to receiving a selection that the determined address and floor fails to match, methods may include terminating the transaction.

### FIELD OF TECHNOLOGY

Aspects of the disclosure relate to device movement profiles and location-based transaction authentications.

### BACKGROUND OF THE DISCLOSURE

As technology continuously improves, malicious actors are becoming more sophisticated and harder to identify. Malicious actors are becoming increasingly efficient in identifying loopholes in different technological landscapes. The malicious actors then use the loopholes to commit nefarious activities. One such loophole relates to payment processing in metropolitan cities. Existing fraud prevention systems leverage traditional payment positioning technology (such as geolocation checks) to identify fraudulent transactions. Traditional payment positioning technology determines a location using latitude and longitude measurements. However, traditional payment processing technology does not account for fraudulent transactions occurring in the same location at different altitudes, such as on different floors in multi-level buildings.

Additionally, the increase in the use of card not present (“CNP”) transactions have created a greater exposure to malicious actors. The augmented landscape of integrating payment cards with various devices like mobile phones, smart watches, etc., have created greater security vulnerabilities regarding payment processing applications.

Therefore, it would be desirable to provide a system using a gyroscopic chip to determine elevation and swiping patterns of customers in order to prevent fraudulent transactions by increasing the number and accuracy of authentication factors.

### SUMMARY OF THE DISCLOSURE

Systems, apparatus and methods for tracking and monitoring customer transactions are provided.

The methods may include using a gyroscopic chip. The gyroscopic chip may have a length of 2-3 millimeters. The gyroscopic chip may have any other suitable length. The gyroscopic chip may be part of a payment device. The gyroscopic chip may be disposed on the payment device. The gyroscopic chip may be disposed in the payment device. The gyroscopic chip may be a silicon chip. The gyroscopic chip may include a microprocessor. The gyroscopic chip may include a central processing unit (“CPU”). The gyroscopic chip may include a graphical processing unit (“GPU”). The gyroscopic chip may include a plurality of circuits. The gyroscopic chip may include any other suitable microchip components.

The payment device may include a credit card. The payment device may include a smart watch. The payment device may include a mobile device, such as a smart phone, tablet and/or any other suitable mobile device. The payment device may include a digital wallet. The digital wallet may be used to initiate the transaction. The payment device may be associated with a user.

The payment device may initiate a transaction. Initiating the transaction may include pre-authenticating the transaction. Pre-authenticating the transaction may include swiping, tapping or inserting the payment device at a payment terminal. The payment terminal may be a point of sale (“PoS”) device, an automated teller machine (“ATM”) and/or any other suitable payment terminal.

Pre-authenticating the transaction may include requesting a pin from the user. The pin may be associated with the payment device. The payment terminal may include a keypad, touchscreen and/or any other suitable user interface. The keypad, touchscreen and any other suitable user interface may be configured to receive the pin from the user. The pin may be used to authenticate the user.

Pre-authenticating the transaction may include transmitting user-related data from the payment device to the payment terminal. User-related data may include user identification, user account information, user billing information and/or any other suitable user-related transaction information. Upon receiving the user-related data, the payment terminal may verify that the user-related data is valid. The payment terminal may be in electronic communication with an entity. The entity may be a financial entity. The entity may be any suitable entity. The entity may verify that the user-related data corresponds to user-related data stored at the entity.

The methods may include capturing first data relating to the transaction. The first data may be captured using a first sensor. The first sensor may be included in the gyroscopic chip. The first sensor may be a sensor that measures angular velocity. The first sensor may be a gyroscope. The gyroscope may be a micro-electro-mechanical system (“MEMS”) gyroscope. The gyroscope may be any other suitable gyroscope. The first sensor may be any suitable sensor.

The first data may include data relating to rotational motion of the payment device during pre-authentication of the transaction. Rotational motion may include a swiping motion, a tapping motion, an inserting motion and/or any other suitable rotational motion. For example, the first sensor may capture how the user holds a credit card before swiping/inserting/tapping, after swiping/inserting/tapping and/or at the time of swiping/inserting/tapping. When the payment device is a mobile device, smartphone or a smart watch, the first sensor may capture how the payment device is held before/during/after initiating the pre-authentication.

The first data may include data relating to an amount of time it takes to move the payment device from one location to another. For example, the user may remove the payment device from a wallet in a first amount of time, such as 52 seconds. The user may return the payment device to the wallet in a second amount of time. The second amount of time may be greater than the first amount of time. For example, the second amount of time may be 74 seconds. The second amount of time may be less than the first amount of time. For example, the second amount of time may be 33 seconds. The first sensor may capture the movement of the payment device at different locations. The first sensor may capture the movement of the payment device, as it is being moved around.

The methods may include capturing second data relating to the transaction. The second data may be captured using a second sensor. The second sensor may be included in the gyroscopic chip. The second sensor may be a sensor that measures height of an object relative to a base level. The second sensor may be a altimeter. The second sensor may be any other suitable sensor. The base level may be ground level. The base level may be a predetermined ground level. The predetermined ground level may be sea level. The predetermined ground level may be below sea level.

The second data may include data relating to an elevation level of the payment device during pre-authentication of the transaction. In many metropolitan areas, there may be buildings that include multiple floors. Buildings, such as houses, stores, apartments, etc., may be divided into floors. Each floor may represent a different level within a building. Buildings may include one or more floors. Floors may be numbered sequentially. Floors may not be numbered sequentially. Floors may be numbered starting from a ground floor. Floors may be numbered starting from a floor that is below the ground floor. The second sensor may be configured to measure the elevation level of the payment device. The elevation level of the payment device may be leveraged to obtain a number of a floor at which the transaction is being attempted.

The methods may include using an artificial intelligence (“AI”) engine. The AI engine may operate on a processor. The processor may be included in the gyroscopic chip. The processor may be included in the payment device. The AI engine may operate with a large language model (“LLM”).

The AI engine may include progressive learning algorithms. The progressive learning algorithms may ingest training data. The progressive learning algorithms may analyze the ingested training data. The progressive learning algorithms may analyze the training data for correlations and patterns within the data. The progressive learning algorithms may use the analyzed correlations and patterns to generate outputs. The AI engine may update the progressive learning algorithms based on the generated outputs curated/retrieved from the analyzed correlations and patterns.

The AI engine may include machine learning algorithms. Machine learning algorithms may enable the AI engine to learn from experience without specific instructional programming. The AI engine may include deep learning algorithms. Deep learning algorithms may utilize neural networks. Neural networks may use interconnected nodes or neurons in a layered structure to analyze data and generate outputs.

The methods may include generating a baseline movement profile for the user. The methods may include using the AI engine to generate the baseline movement profile for the user. The baseline movement profile may include movement patterns of the user. The movement patterns may be identified from pre-authentications of one or more previously-executed transactions. The AI engine may be in electronic communication with a database. The database may include historical movement data relating to the one or more previously-executed transactions. The AI engine may analyze the historical movement data. The AI engine may output the baseline movement profile based on the analyzing of the historical movement data.

The baseline movement profile may include a specific hand motion used when tapping/swiping or inserting the payment device in/at a payment terminal. The baseline movement profile may include an amount of time it takes when tapping/swiping or inserting the payment device in/at a payment terminal. The baseline movement profile may include a specific hand motion used when removing the payment device from the payment terminal after pre-authenticating the transaction. The baseline movement profile may include any other suitable movements and timeframes that are captured in relation to the payment device.

In response to receiving the first data, the methods may include comparing the captured rotational motion to the baseline movement profile. The comparing may include identifying a number of comparison points between the captured rotational motion and the baseline movement profile. Comparison points may be unique identifiable features within the captured rotational motion that match unique identifiable features within the baseline movement profile. The comparing may include identifying a number of differences between the captured rotational motion and the baseline movement profile. Differences may include unique identifiable features within the captured rotational motion that do not match unique identifiable features within the baseline movement profile. Differences may include unique identifiable features within the baseline movement profile that do not match unique identifiable features within the captured rotational motion.

In response to determining that the rotational motion and the movement patterns differ by a number of differences that are greater than a threshold value, the methods may include terminating the transaction. In response to determining that the rotational motion and the movement patterns differ by a number of differences that are greater than a threshold value, the methods may include transmitting a fraud alert to the user.

Terminating the transaction may include pausing the transaction. Terminating the transaction may include deleting the transaction. Terminating transaction may include quarantining the transaction. Quarantining the transaction may include temporarily isolating the transaction, until the user confirms whether the transaction is an authorized transaction. Terminating the transaction may include any suitable prevention of executing the transaction.

The fraud alert may warn the user that the captured rotational movement does not match the baseline movement profile. The fraud alert may include a first selection, that the user can select, to verify that the transaction is an authorized transaction. The fraud alert may include a second selection, that the user can select, to verify that the transaction is not an authorized selection. In response to receiving the first selection from the user, the transaction may be executed. In response to receiving the second selection from the user, the transaction may be terminated. The responses may be used to further train the AI engine and to update the baseline movement profile.

Simultaneous to the comparing of the rotational motion to the baseline movement profile, the methods may include determining an address and a floor at which the pre-authentication has occurred. The address and floor at which the pre-authentication has occurred may be determined based on the elevation level from the second data together with an identified location of the payment device. The payment device may include an global positioning system (“GPS”) chip. The GPS chip may be used to identify a location of the payment device. The location of the payment device may correspond to an address at which the payment device is located. The elevation level may be used to identify a floor at which the payment device is located.

The methods may include using the identified address to retrieve a satellite photo of the address. Using the satellite photo, the AI engine may determine a height of a building located at the address. Along with the identified height, the elevation level may be used to determine at what floor the payment device is located. Using the satellite photo, the AI engine may identify publicly available information associated with the building. Publicly available information may include property records and/or any other suitable publicly available information. Using the publicly available information, the AI engine may identify whether there are floors that are below ground level. Using the publicly available information, the AI engine may determine a numbering sequence of the floors. In the event that the AI engine cannot confirm a floor at which the transaction was initiated, the methods may include transmitting one or more options to the user. Each option may include a possible floor at which the user may be located. The user may confirm which of the possible floors corresponds to the user's spatial location.

The methods may include transmitting a location verification message to the user. The location verification message may request confirmation that the address and the floor determined by the AI engine matches an address and floor at which the user is located. The location verification message may include a first selection, that the user can select, indicating that the address and floor determined by the AI engine matches the address and floor at which the user is located. The location verification message may include a second selection, that the user can select, indicating that the address and floor determined by the AI engine fails to match the address and floor at which the user is located. In response to receiving the first selection from the user, the transaction may be executed. In response to receiving the second selection from the user, the transaction may be terminated.

The payment device may be included in an internet of things (“IoT”) network. The IoT network may include a plurality of IoT devices. The plurality of IoT devices may include one or more interconnected devices that each include sensors, software, and network connections. The plurality of IoT devices may collect and share data. The plurality IoT devices may communicate and interact with each other and with other systems, for automation, data collection, remote control and any other suitable IoT-related tasks.

The plurality of IoT devices included in the IoT network may include devices like refrigerators, televisions, cameras, ovens and/or any other suitable IoT devices. The methods may include identifying a most recently accessed IoT device from the plurality of IoT devices. A most recently accessed device may include a device that the user used within a given timeframe. The methods may include transmitting the fraud alert and location verification message to the most recently accessed IoT device. The fraud alert and location verification message may be displayed on a screen included in the most recently accessed IoT device.

For example, the gyroscopic chip may identify that the user last used the refrigerator. In response to identifying that the user last used the refrigerator, the fraud alert and location verification message may be transmitted to and displayed on a screen included in the refrigerator.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout and in which:

FIG. 1 shows an illustrative diagram in accordance with principles of the disclosure;

FIG. 2 shows another illustrative diagram in accordance with principles of the disclosure;

FIG. 3 shows another illustrative diagram in accordance with principles of the disclosure;

FIG. 4 shows another illustrative diagram in accordance with principles of the disclosure; and

FIG. 5 shows another illustrative diagram in accordance with principles of the disclosure.

### DETAILED DESCRIPTION OF THE DISCLOSURE

Systems, apparatus and methods for tracking and monitoring customer transactions are provided.

The apparatus may include gyroscopic chip. The gyroscopic chip may have a length of 2-3 millimeters. The gyroscopic chip may have any other suitable length. The gyroscopic chip may be part of a payment device. The gyroscopic chip may be disposed on the payment device. The gyroscopic chip may be disposed in the payment device. The gyroscopic chip may be a silicon chip. The gyroscopic chip may include a microprocessor. The gyroscopic chip may include a central processing unit (“CPU”). The gyroscopic chip may include a graphical processing unit (“GPU”). The gyroscopic chip may include a plurality of circuits. The gyroscopic chip may include any other suitable microchip components.

The payment device may include a credit card. The payment device may include a smart watch. The payment device may include a mobile device, such as a smart phone, tablet and/or any other suitable mobile device. The payment device may include a digital wallet. The digital wallet may be used to initiate the transaction. The payment device may be associated with a user.

The payment device may initiate a transaction. Initiating the transaction may include pre-authenticating the transaction. Pre-authenticating the transaction may include swiping, tapping or inserting the payment device at a payment terminal. The payment terminal may be a point of sale (“PoS”) device, an automated teller machine (“ATM”) and/or any other suitable payment terminal.

Pre-authenticating the transaction may include transmitting user-related data from the payment device to the payment terminal. User-related data may include user identification, user account information, user billing information and/or any other suitable user-related transaction information. Upon receiving the user-related data, the payment terminal may verify that the user-related data is valid. The payment terminal may be in electronic communication with an entity. The entity may be a financial entity. The entity may be any other suitable entity. The entity may verify that the user-related data corresponds to user-related data retrieved stored at entity.

The gyroscopic chip may include a first sensor. The first sensor may capture first data relating to the transaction. The first sensor may be included in the gyroscopic chip. The first sensor may be a sensor that measures angular velocity. The first sensor may be a gyroscope. The gyroscope may be a micro-electro-mechanical system (“MEMS”) gyroscope. The gyroscope may be any other suitable gyroscope. The first sensor may be any suitable sensor.

The first data may include data relating to rotational motion of the payment device during pre-authentication of the transaction. Rotational motion may include a swiping motion, a tapping motion, an inserting motion and/or any other suitable rotational motion. For example, the first sensor may capture how the user holds a credit card before swiping/inserting/tapping, after swiping/inserting/tapping and/or at the time of swiping/inserting/tapping. When the payment device is a mobile device, smartphone or a smart watch, the first sensor may capture how the payment device is held before/during/after initiating the pre-authentication.

The first data may include data relating to an amount of time it takes to move the payment device from one location to another. The first sensor may capture the movement of the payment device at different locations.

The gyroscopic chip may include a second sensor. The second sensor may capture second data relating to the transaction. The second sensor may be included in the gyroscopic chip. The second sensor may be a sensor that measures height of an object relative to a base level. The second sensor may be a altimeter. The second sensor may be any other suitable sensor. The base level may be ground level. The base level may be a predetermined ground level. The predetermined ground level may be sea level. The predetermined ground level may be below sea level.

The second data may include data relating to an elevation level of the payment device during pre-authentication of the transaction. In many metropolitan areas, there may be buildings that include multiple floors. Buildings, such as houses, stores, apartments, etc., may be divided into floors. Each floor may represent a different level within a building. Buildings may include one or more floors. Floors may be numbered sequentially. Floors may not be numbered sequentially. Floors may be numbered starting from a ground floor. Floors may be numbered starting from a floor that is below the ground floor. The second sensor may be configured to measure the elevation level of the payment device. The elevation level of the payment device may be leveraged to obtain a number of a floor at which the transaction is being attempted.

The gyroscopic chip may include an artificial intelligence (“AI”) engine. The AI engine may operate on a processor. The processor may be included in the gyroscopic chip. The processor may be included in the payment device. The AI engine may operate with a large language model (“LLM”).

The AI engine may include progressive learning algorithms. The progressive learning algorithms may ingest training data. The progressive learning algorithms may analyze the ingested training data. The progressive learning algorithms may analyze the training data for correlations and patterns within the data. The progressive learning algorithms may use the analyzed correlations and patterns to generate outputs. The AI engine may update the progressive learning algorithms based on the generated outputs curated/retrieved from the analyzed correlations and patterns.

The AI engine may include machine learning algorithms. Machine learning algorithms may enable the AI engine to learn from experience without specific instructional programming. The AI engine may include deep learning algorithms. Deep learning algorithms may utilize neural networks. Neural networks may use interconnected nodes or neurons in a layered structure to analyze data and generate outputs.

The AI engine may generate a baseline movement profile for the user. The baseline movement profile may include movement patterns of the user. The movement patterns may be identified from pre-authentications of one or more previously-executed transactions. The AI engine may be in electronic communication with a database. The database may include historical movement data relating to the one or more previously-executed transactions. The AI engine may analyze the historical movement data. The AI engine may output the baseline movement profile based on the analyzing of the historical movement data.

The baseline movement profile may include a specific hand motion used when tapping/swiping or inserting the payment device in/at a payment terminal. The baseline movement profile may include an amount of time it takes when tapping/swiping or inserting the payment device in/at a payment terminal. The baseline movement profile may include a specific hand motion used when removing the payment device from the payment terminal after pre-authenticating the transaction. The baseline movement profile may include any other suitable movements and timeframes that are captured in relation to the payment device.

In response to receiving the first data, the AI engine may compare the captured rotational motion to the baseline movement profile. The comparing may include identifying a number of comparison points between the captured rotational motion and the baseline movement profile. Comparison points may be unique identifiable features within the captured rotational motion that match unique identifiable features within the baseline movement profile. The comparing may include identifying a number of differences between the captured rotational motion and the baseline movement profile. Differences may be unique identifiable features within the captured rotational motion that do not match unique identifiable features within the baseline movement profile. Differences may include unique identifiable features within the baseline movement profile that do not match unique identifiable features within the captured rotational motion.

In response to determining that the rotational motion and the movement patterns differ by a number of differences that are greater than a threshold value, the transaction may be terminated. In response to determining that the rotational motion and the movement patterns differ by a number of differences that are greater than a threshold value, a fraud alert may be transmitted to the user.

Terminating the transaction may include pausing the transaction. Terminating the transaction may include deleting the transaction. Terminating transaction may include quarantining the transaction. Quarantining the transaction may include temporarily isolating the transaction, until the user confirms whether the transaction is an authorized transaction. Terminating the transaction may include any suitable prevention of executing the transaction.

The fraud alert may warn the user that the captured rotational movement does not match the baseline movement profile. The fraud alert may include a first selection, that the user can select, to verify that the transaction is an authorized transaction. The fraud alert may include a second selection, that the user can select, to verify that the transaction is not an authorized selection. In response to receiving the first selection from the user, the transaction may be executed. In response to receiving the second selection from the user, the transaction may be terminated. The responses may be used to further train the AI engine and to update the baseline movement profile.

Simultaneous to the comparing of the rotational motion to the baseline movement profile, the AI engine may determine an address and a floor at which the pre-authentication has occurred. The address and floor at which the pre-authentication has occurred may be determined based on the elevation level from the second data together with an identified location of the payment device. The payment device may include an global positioning system (“GPS”) chip. The GPS chip may be used to identify a location of the payment device. The location of the payment device may correspond to an address at which the payment device is located. The elevation level may be used to identify a building floor at which the payment device is located.

The AI engine may use the identified address to retrieve a satellite photo of the address. Using the satellite photo, the AI engine may determine a height of a building located at the address. Along with the identified height, the elevation level may be used to determine at what floor the payment device is located. Using the satellite photo, the AI engine may identify publicly available information associated with the building. Publicly available information may include property records and/or any other suitable publicly available information. Using the publicly available information, the AI engine may identify whether there are floors that are below ground level. Using the publicly available information, the AI engine may determine a numbering sequence of the floors. In the event that the AI engine cannot confirm a floor at which the transaction was initiated, the methods may include transmitting one or more options to the user. Each option may include a possible floor at which the user may be located. The user may confirm which of the possible floors corresponds to the user's spatial location.

After determining the address and the floor that the payment device is located, a location verification message may be transmitted to the user. The location verification message may request confirmation that the address and the floor determined by the AI engine matches an address and floor at which the user is located. The location verification message may include a first selection, that the user can select, indicating that the address and floor determined by the AI engine matches the address and floor at which the user is located. The location verification message may include a second selection, that the user can select, indicating that the address and floor determined by the AI engine does not match the address and floor at which the user is located don't match. In response to receiving the first selection from the user, the transaction may be executed. In response to receiving the second selection from the user, the transaction may be terminated.

The payment device may be included in an internet of things (“IoT”) network. The IoT network may include a plurality of IoT devices. The plurality of IoT devices may include one or more interconnected devices that each include sensors, software, and network connections. The plurality of IoT devices may collect and share data. The plurality of IoT devices may communicate and interact with each other and with other systems, for automation, data collection, remote control and any other suitable IoT-related tasks.

The plurality of IoT devices included in the IoT network may include devices like refrigerators, televisions, cameras, ovens and/or any other suitable IoT devices. The AI engine may identify a most recently accessed IoT device from the plurality of IoT devices. The fraud alert and location verification message may be transmitted to the most recently accessed IoT device. A most recently accessed device may include a device that the user used within a given timeframe. The fraud alert and location verification message may be displayed on a screen included in the most recently accessed IoT device.

Illustrative method steps may be combined. For example, an illustrative method may include steps shown in connection with another illustrative method.

The steps of methods may be performed in an order other than the order shown or described herein. Embodiments may omit steps shown or described in connection with illustrative methods. Embodiments may include steps that are neither shown nor described in connection with illustrative methods.

Apparatus may omit features shown or described in connection with illustrative apparatus. Embodiments may include features that are neither shown nor described in connection with the illustrative apparatus. Features of illustrative apparatus may be combined. For example, an illustrative embodiment may include features shown in connection with another illustrative embodiment.

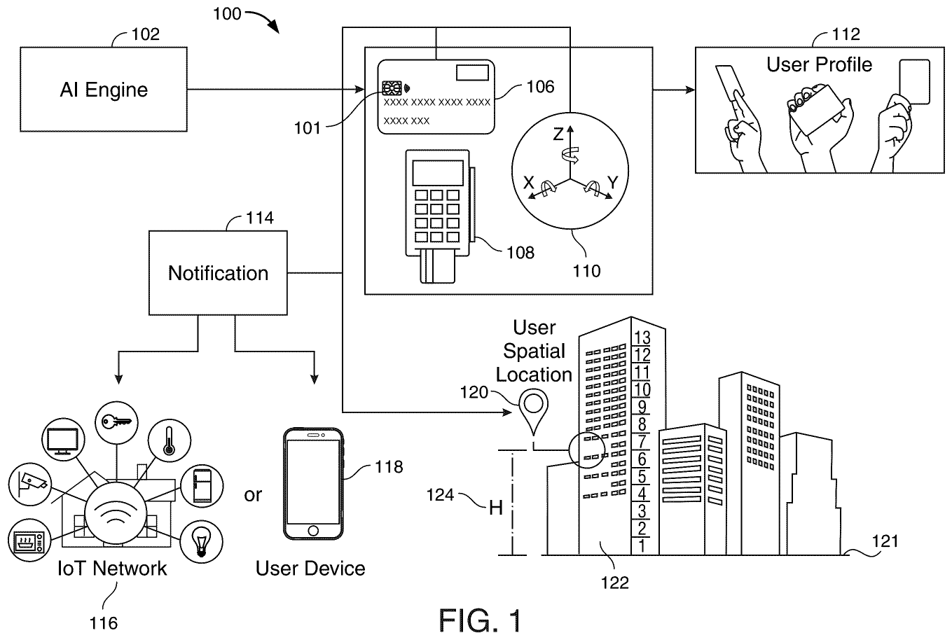

FIG. 1 shows illustrative transaction authentication process 100. Transaction authentication process 100 may include payment device 106. Payment device 106 may be associated with a user. Payment device 106 may include a credit card (as shown), a mobile device, smart watch and/or any other suitable payment device (not shown). Payment device 106 may include gyroscopic chip 101.

Payment device 106 may initiate a transaction with payment terminal 108. Payment terminal 108 may be a point of sale (“Pos”) device, an automated teller machine (“ATM”) and/or any other suitable payment terminal. Initiating the transaction with payment terminal 108 may include pre-authorizing the transaction.

Gyroscopic chip 101 may include a first sensor. The first sensor may measure rotational movement 110 of payment device 106 when pre-authorizing the transaction. Rotational movement 110 may include movement along the x-axis, y-axis and/or z-axis.

Payment terminal 108 may be located in building 122. Gyroscopic chip 101 may include a second sensor. The second sensor may measure height 124. Height 124 may be the height of payment device 106 relative to ground 121. The second sensor may measure height 124 when pre-authorizing the transaction.

Payment device 106 may be in electronic communication with artificial intelligence (“AI”) engine 102. AI engine 102 may analyze data from a historical database (not shown). The historical database may store data relating to pre-authorizations from successfully executed previous transactions. The historical database may store data relating to the user's movements when handling payment device 106.

Based on the data, AI engine 102 may generate user profile 112. User profile 112 may include a specific hand motion used when tapping/swiping and/or inserting payment device 106 in payment terminal 108. User profile 112 may include an amount of time it takes when tapping/swiping and/or inserting payment device 106 in payment terminal 108. User profile 112 may include a specific hand motion used when removing payment device 106 from payment terminal 108 after pre-authenticating the transaction. User profile 112 may include any other suitable movements that are captured in relation to payment device 106.

AI engine 102 may compare rotational motion 110 to user profile 112. In response to identifying that a number of differences between rotational motion 110 and user profile 112 is greater than a threshold value, payment device 106 may generate notification 114.

Payment device 106 may include a global positioning system (“GPS”) chip (not shown). The GPS chip may identify an address for building 122. AI engine 102 may use the identified address and height 124 to determine a floor at which the pre-authorization is occurring. Building 122 may include a plurality of floors. The plurality of floors may be numbered sequentially starting from ground level 121. In response to determining the floor at which the pre-authorization is occurring, payment device 106 may generate notification 114.

Notification 114 may notify the user that the number of differences between rotational motion 110 to user profile 112 is greater than a threshold value. Notification 114 may request confirmation from the user whether the determined floor is the same location as user location 120. For example, AI engine 102 may determine that the user is located at the 7^{th} floor. As such, notification 114 may request confirmation from the user that the user is located at the 7^{th} floor.

Notification 114 may be transmitted user device 118. Notification 114 may be transmitted to IoT network 116. IoT network 116 may include a plurality of IoT devices. Payment device 106 may determine which of the plurality of IoT devices were most recently accessed. Notification 114 may be transmitted to and displayed on the most recently accessed IoT device. Notification 114 may be transmitted to both user device 118 and IoT network 116.

In response to receiving notification 114 the user may respond. The user may confirm that the transaction is not an authorized transaction. In response to receiving a response that the transaction is not an authorized transaction, the transaction may be terminated. The user may confirm that the transaction is an authorized transaction. In response to receiving a response that the transaction is an authorized transaction, the transaction may be executed.

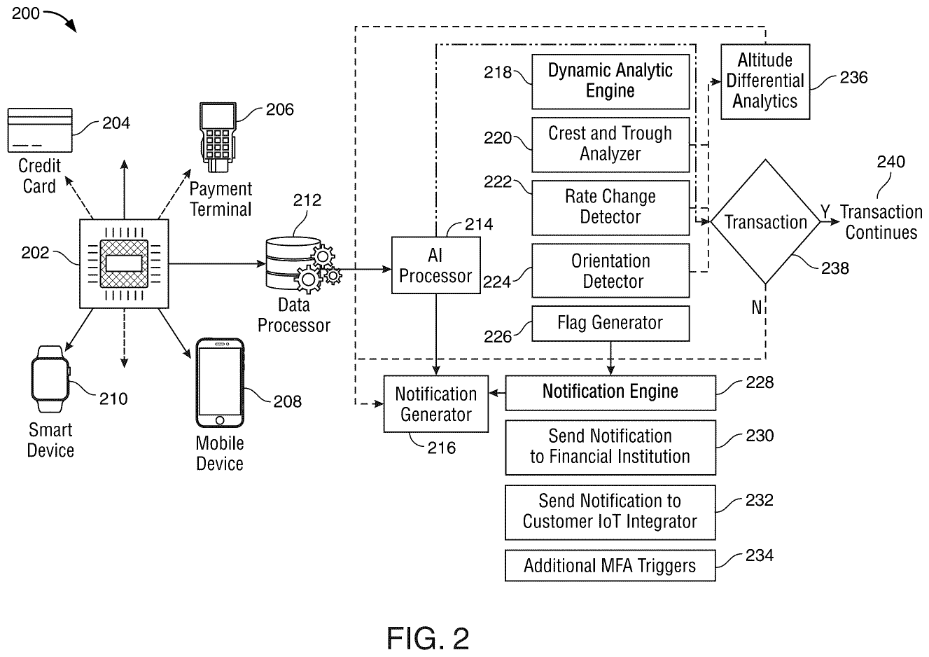

FIG. 2 shows illustrative transaction authentication process 200. Transaction authentication process 200 may have one or more features in common with transaction authentication process 100.

Transaction authentication process 200 may include gyroscopic chip 202. Gyroscopic chip 202 may be disposed on and/or as part of credit card 204. Gyroscopic chip 202 may be disposed on and/or as part of smart device 210. Gyroscopic chip 202 may be disposed on and/or as part of mobile device 208. Gyroscopic chip 202 may be disposed on and/or as part of payment terminal 206.

Gyroscopic chip 202 may be in electronic communication with data processor 212. Data processor 212 may process incoming data from sensors included in gyroscopic chip 202. Data processor 212 may include AI engine 214. AI engine 214 may include dynamic analytic engine 218.

Dynamic analytic engine 218 may include crest and trough analyzer 220, rate change detector 222, orientation detector 224 and flag generator 226.

Gyroscopic chip 202 may measure a height of gyroscopic chip 202 in relation to a predetermined ground level. Crest and through analyzer 220 may identify a crest indicating a highest altitude reached. Crest and through analyzer 220 may identify a baseline indicating a general stationary height. Crest and through analyzer 220 may identify a through indicating a lowest altitude reached. Crest and through analyzer 220 may identify the height of gyroscopic chip 202 based on the identified crest, baseline and trough.

Gyroscopic chip 202 may measure an amount of time it takes for gyroscopic chip 202 to shift from a first location to a second location during pre-authentication of transaction 238. The amount of time it takes for gyroscopic chip 202 to shift from the first location to the second location may be analyzed by rate change detector 222. Gyroscopic chip 202 may change orientations during pre-authentication of transaction 238. Orientation detector 224 may analyze the changes in orientation.

Dynamic analytic engine 218 may identify a mean rate of change and orientation parameters for the user. In response to an initiation of transaction pre-authorization for transaction 238, dynamic analytic engine 218 may compare the mean rate of change and orientation parameters to the identified shift from the first location to the second location and orientation changes for transaction 238.

In response to determining that mean rate of change and orientation parameters matches the identified shift from the first location to the second location and orientation changes for transaction 238, the transaction may be executed at step 240.

In response to determining that mean rate change and orientation parameters fail to match the identified shift from the first location to the second location and orientation changes for transaction 238, flag generator 226 may flag transaction 238.

Flag generator 226 may be in electronic communication with notification generator 216. Notification generator 216 may be operated by notification engine 228. Notification engine 228 may transmit notification 230 to a financial institution associated with transaction 238. Notification engine 228 may transmit notification 234 to the user via IoT network 232. Notification engine 228 may initiate other multifactor authentication protocols 236.

Data processor 212 may include altitude differential analytics 238. Altitude differential analytics 238 may be used to identify other fraudulent transactions occurring at different locations within a predetermined perimeter area.

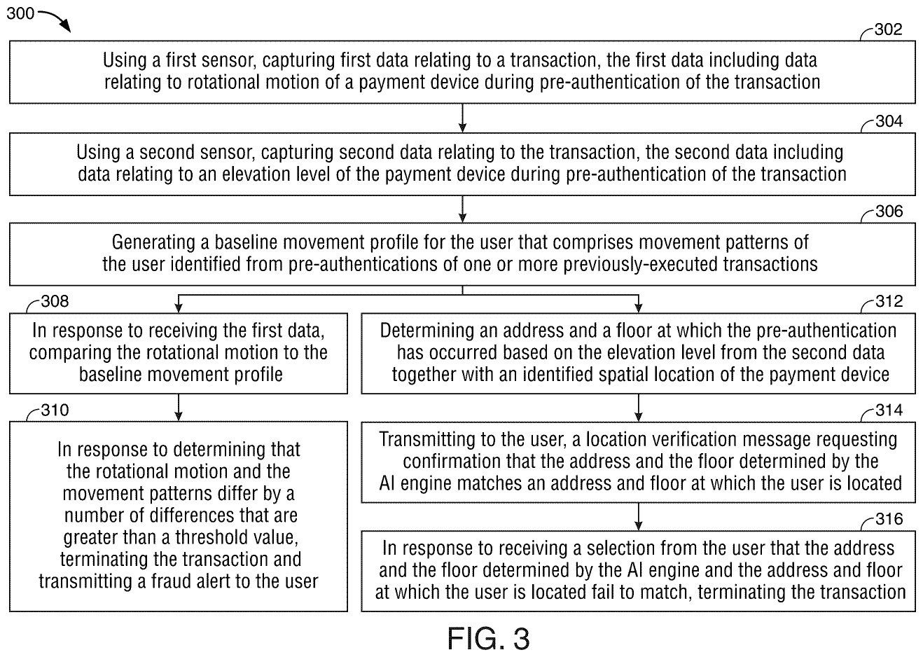

FIG. 3 shows illustrative transaction authentication process 300. Transaction authentication process 300 may have one or more features in common with transaction authentication process 100 and transaction authentication process 200.

At step 302, first data may be captured using a first sensor. The first data may include data relating to rotational movement of a payment device during pre-authentication of a transaction. At step 304, second data may be captured using a second sensor. The second data may include data relating to an elevation level of the payment device during the pre-authentication of the transaction.

At step 306, a baseline movement profile may be generated. The baseline movement profile may include movement patterns of a user associated with the payment device. The movement patterns may be identified from pre-authentications of one or more previously-executed transactions.

In response to receiving the first data, step 308 may include comparing the rotational motion to the baseline movement profile. In response to determining that the rotational motion and the movement patterns differ by a number of differences that are greater than a threshold value, step 310 may include terminating the transaction and transmitting a fraud alert to the user.

Simultaneous with step 308, step 312 may include determining an address and floor at which the pre-authentication has occurred. The address and floor may be determined using the elevation level from the second data along with an identified location of the payment device.

Step 314 may include transmitting to the user, a location verification message. The location verification message may request confirmation from the user that the determined address and floor matches the address and floor at which the user is located.

In response to receiving a selection from the user that the determined address and floor does not match the address and floor at which the user is located, step 316 may include terminating the transaction.

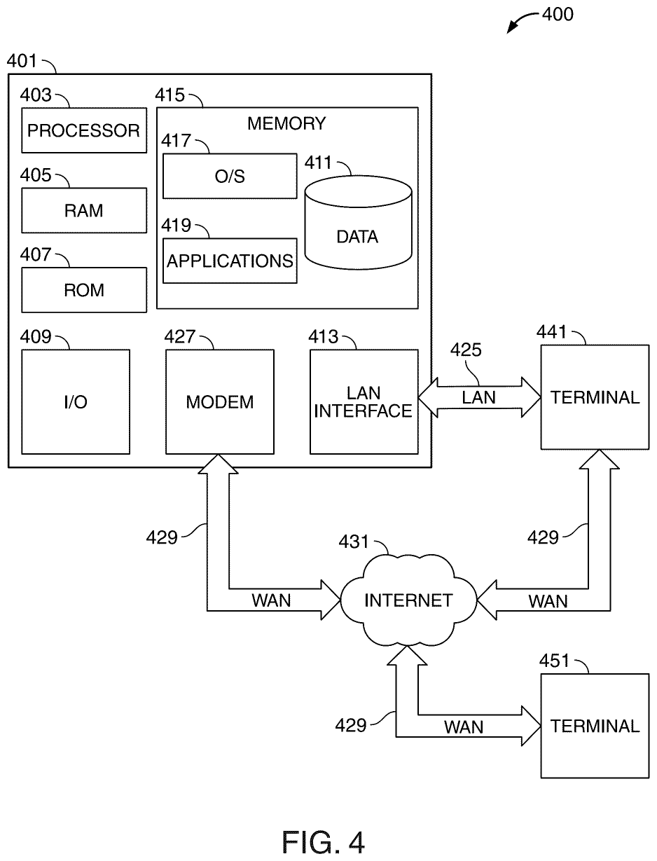

FIG. 4 shows an illustrative block diagram of system 400 that includes computer 401. Computer 401 may alternatively be referred to herein as an “engine,” “server,” or a “computing device.” Computer 401 may be a workstation, desktop, laptop, tablet, smartphone and/or any other suitable computing device. Elements of system 400, including computer 401, may be used to implement various aspects of the systems and methods disclosed herein. Each of the systems, methods and algorithms illustrated above/below may include some or all of the elements and apparatus of system 400.

Computer 401 may include processor 403 for controlling the operation of the device and its associated components, and may include RAM 405, ROM 407, input/output (“I/O”) 409, and a non-transitory or non-volatile memory 415. Machine-readable memory may be configured to store information in machine-readable data structures. Processor 403 may also execute software running on the computer. Other components commonly used for computers, such as EEPROM or flash memory or any other suitable components, may also be part of computer 401.

Memory 415 may include any suitable permanent storage technology, such as a hard drive. Memory 415 may store software including the operating system 417 and application program(s) 419 together with any data 411 needed for the operation of the system 400. Memory 415 may also store videos, text and/or audio assistance files. The data stored in memory 415 may also be stored in cache memory and/or any other suitable memory.

I/O module 409 may include connectivity to a microphone, keyboard, touch screen, mouse and/or stylus through which input may be provided into computer 401. The input may include input relating to cursor movement. The input/output module may also include one or more speakers for providing audio output and a video display device for providing textual, audio, audiovisual and/or graphical output. The input and output may be related to computer application functionality.

System 400 may be connected to other systems via a local area network (“LAN”) interface 413. System 400 may operate in a networked environment supporting connections to one or more remote computers, such as terminals 441 and 451. Terminals 441 and 451 may be personal computers or servers that include many or all of the elements described above relative to system 400. The network connections depicted in FIG. 4 include LAN 425 and a wide area network (“WAN”) 429 but may also include other networks. When used in a LAN networking environment, computer 401 may connect to LAN 425 through LAN interface 413 or an adapter. When used in a WAN networking environment, computer 401 may include modem 427 or other means for establishing communications over WAN 429, such as Internet 431.

It will be appreciated if the network connections shown are illustrative and other means of establishing a communications link between computers may be used. The existence of various well-known protocols such as TCP/IP, Ethernet, FTP, HTTP and the like is presumed, and the system can be operated in a client-server configuration to permit retrieval of data from a web-based server or application programming interface (“API”). Web-based, for the purposes of this application, is to be understood to include a cloud-based system. The web-based server may transmit data to any other suitable computer system. The web-based server may also send computer-readable instructions, together with the data, to any suitable computer system. The computer-readable instructions may include instructions to store the data in cache memory, the hard drive, secondary memory and/or any other suitable memory.

Additionally, application program(s) 419, which may be used by computer 401, may include computer executable instructions for invoking functionality related to communication, such as e-mail, Short Message Service (“SMS”), and voice input and speech recognition applications. Application program(s) 419 (which may be alternatively referred to herein as “plugins,” “applications,” or “apps”) may include computer executable instructions for invoking functionality related to performing various tasks. Application program(s) 419 may utilize one or more algorithms that process received executable instructions, perform power management routines or other suitable tasks.

The invention may be described in the context of computer-executable instructions, such as application(s) 419, being executed by a computer. Generally, programs include routines, programs, objects, components, data structures, etc., that perform particular tasks or implement particular data types. The invention may also be practiced in distributed computing environments where tasks are performed by remote processing devices that are linked through a communications network. In a distributed computing environment, programs may be located in both local and remote computer storage media including memory storage devices. It should be noted that such programs may be considered for the purposes of this application, as engines with respect to the performance of the particular tasks to which the programs are assigned.

Computer 401 and/or terminals 441 and 451 may also include various other components, such as a battery, speaker and/or antennas (not shown). Components of computer 401 may be linked by a system bus, wirelessly or by other suitable interconnections. Components of computer 401 may be present on one or more circuit boards. In some embodiments, the components may be integrated into a single chip. The chip may be silicon-based.

Terminal 441 and/or terminal 451 may be portable devices such as a laptop, cell phone, tablet, smartphone or any other computing system for receiving, storing, transmitting and/or displaying relevant information. Terminal 441 and/or terminal 451 may be one or more user devices. Terminals 441 and 451 may be identical to system 400 or different. The differences may be related to hardware components and/or software components.

The invention may be operational with numerous other general purpose or special purpose computing system environments or configurations. Examples of well-known computing systems, environments, and/or configurations that may be suitable for use with the invention include, but are not limited to, personal computers, server computers, hand-held or laptop devices, tablets, mobile phones, smart phones and/or other personal digital assistants (“PDAs”), multiprocessor systems, microprocessor-based systems, cloud-based systems, programmable consumer electronics, network PCs, minicomputers, mainframe computers, distributed computing environments that include any of the above systems or devices, and the like.

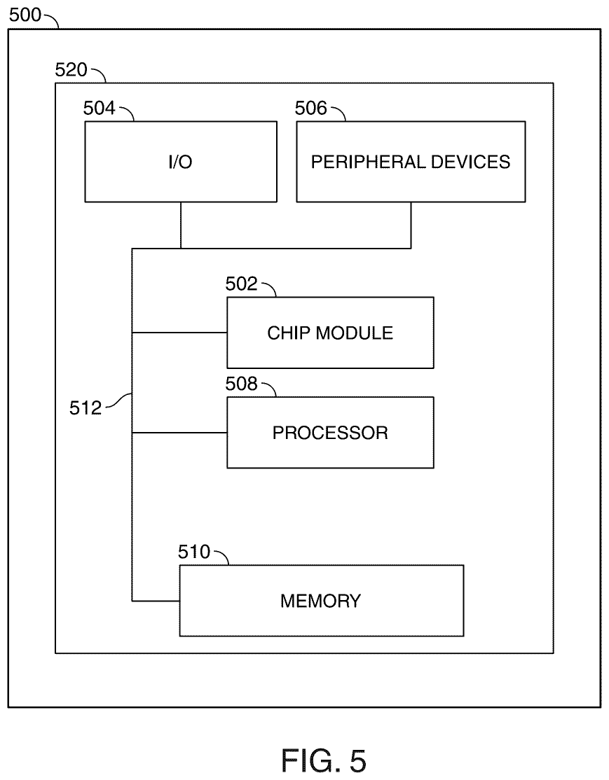

FIG. 5 shows illustrative apparatus 500 that may be configured in accordance with the principles of the disclosure. Apparatus 500 may be a computing device. Apparatus 500 may include one or more features of the apparatus shown in FIG. 4. Apparatus 500 may include chip module 502, which may include one or more integrated circuits, and which may include logic configured to perform any suitable logical operations.

Apparatus 500 may include one or more of the following components: I/O circuitry 504, which may include a transmitter device and a receiver device and may interface with fiber optic cable, coaxial cable, telephone lines, wireless devices, PHY layer hardware, a keypad/display control device or any other suitable media or devices; peripheral devices 506, which may include counter timers, real-time timers, power-on reset generators or any other suitable peripheral devices; logical processing device 508, which may compute data structural information and structural parameters of the data; and machine-readable memory 510.

Machine-readable memory 510 may be configured to store in machine-readable data structures: machine executable instructions, (which may be alternatively referred to herein as “computer instructions” or “computer code”), applications such as applications 519, signals, and/or any other suitable information or data structures.

Components 502, 504, 506, 508, and 510 may be coupled together by a system bus or other interconnections 512 and may be present on one or more circuit boards such as circuit board 520. In some embodiments, the components may be integrated into a single chip. The chip may be silicon-based.

As will be appreciated by one of ordinary skill in the art, the present invention may be embodied as an apparatus (including, for example, a system, a machine, a device, a computer program product, and/or the like), as a method (including, for example, a process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more special-purpose circuits perform the functions by executing one or more computer-executable program code portions embodied in a computer-readable medium, and/or having one or more application-specific circuits perform the function. As such, once the software and/or hardware of the claimed invention is implemented the computer device and application-specific circuits associated therewith are deemed specialized computer devices capable of improving technology associated with intelligently controlling data transfers between network connected devices and a platform layer application server.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F #.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These one or more computer-executable program code portions may be provided to a processor of a special purpose computer for intelligently controlling data transfers between network connected devices and a platform layer application server, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

In some aspects of the described methods and systems, a regulated machine learning (ML) model is utilized. The regulated ML model is designed to make incremental learning adjustments in tandem with the determinations made by the machine learning engine and communicated to the regulated ML model. The machine learning engine accesses data outputted from storage of previous datasets, and it is trained to use data from the incoming dataset to collectively formulate and approve incremental learning adjustments with the regulated ML model. The regulated ML model and the machine learning engine may consider input data patterns, output data patterns, thresholds for model performance, and/or distributions of identified patterns between different ML models.

One of ordinary skill in the art will appreciate that the steps shown and described herein may be performed in other than the recited order and that one or more steps illustrated may be optional. The methods of the above-referenced embodiments may involve the use of any suitable elements, steps, computer-executable instructions, or computer-readable data structures. In this regard, other embodiments are disclosed herein as well that can be partially or wholly implemented on a computer-readable medium, for example, by storing computer-executable instructions or modules or by utilizing computer-readable data structures.

Thus, methods and apparatus for GYROSCOPIC CHIP FOR FRAUD PREVENTION are provided. Persons skilled in the art will appreciate that the present disclosure can be practiced by other than the described embodiments, which are presented for purposes of illustration rather than of limitation and that the present disclosure is limited only by the claims that follow.

What is claimed is:

1. A gyroscopic chip for tracking and monitoring customer transactions, the gyroscopic chip configured to be part of a payment device associated with a user, the gyroscopic chip comprising:
a first sensor configured to capture first data relating to a transaction, the first data including data relating to rotational motion of the payment device during pre-authentication of the transaction;
a second sensor configured to capture second data relating to the transaction, the second data including data relating to an elevation level of the payment device during the pre-authentication of the transaction, the elevation level being measured relative to a predetermined ground level;
a processor configured to receive the first data and the second data; and
an artificial intelligence (“AI”) engine operating on the processor and configured to:
generate a baseline movement profile for the user that comprises movement patterns of the user identified from pre-authentications of one or more previously-executed transactions;
in response to receiving the first data, compare the rotational motion to the baseline movement profile, wherein, when the rotational motion and the movement patterns differ by a number of differences that are greater than a threshold value, the processor is further configured to:
terminate the transaction; and
transmit a fraud alert to the user;
simultaneous to the comparing of the rotational motion to the baseline movement profile, using the elevation level from the second data together with an identified location of the payment device to determine an address and a floor at which the pre-authentication has occurred; and
transmit to the user, via the processor, a location verification message requesting confirmation that the address and the floor determined by the AI engine matches an address and floor at which the user is located; wherein the processor is configured to terminate the transaction in response to receiving a selection from the user that the address and the floor determined by the AI engine and the address and floor at which the user is located don't match.

2. The gyroscopic chip of claim 1 wherein the payment device is a credit card.

3. The gyroscopic chip of claim 1 wherein the payment device is a mobile device.

4. The gyroscopic chip of claim 1 wherein the payment device is a smart watch.

5. The gyroscopic chip of claim 1 wherein the first sensor is a gyroscope.

6. The gyroscopic chip of claim 1 wherein the second sensor is an altimeter.

7. The gyroscopic chip of claim 1 wherein the gyroscopic chip further includes a global positioning system (“GPS”) chip used to identify the location of the payment device.

8. The gyroscopic chip of claim 1 wherein the payment device is included in an internet of things (“IoT”) network including a plurality of IoT devices.

9. The gyroscopic chip of claim 8 wherein the gyroscopic chip is further configured to:
identify a most recently accessed IoT device from the plurality of IoT devices; and
transmit the fraud alert and location verification message to the most recently accessed IoT device.

10. The gyroscopic chip of claim 1 wherein the pre-authentication of the transaction occurs at a point of service (“PoS”) terminal.

11. A method for tracking and monitoring customer transactions, the method including using a gyroscopic chip, the gyroscopic chip being part of a payment device, the payment device associated with a user, the method comprising:
capturing, using a first sensor included in the gyroscopic chip, first data relating to a transaction, the first data including data relating to rotational motion of the payment device during pre-authentication of the transaction;
capturing, using a second sensor included in the gyroscopic chip, second data relating to the transaction, the second data include data relating to an elevation level of the payment device during pre-authentication of the transaction, the elevation level being measured relative to a predetermined ground level;
using an artificial intelligence (“AI”) engine, generating a baseline movement profile for the user that comprises movement patterns of the user identified from pre-authentications of one or more previously-executed transactions;
in response to receiving the first data, comparing the rotational motion to the baseline movement profile;
in response to determining that the rotational motion and the movement patterns differ by a number of differences that are greater than a threshold value:
terminating the transaction; and
transmitting a fraud alert to the user;
simultaneous to the comparing of the rotational motion to the baseline movement profile, determining an address and a floor at which the pre-authentication has occurred based on the elevation level from the second data together with an identified location of the payment device;
transmitting to the user, a location verification message requesting confirmation that the address and the floor determined by the AI engine matches an address and floor at which the user is located; and
in response to receiving a selection from the user that the address and the floor determined by the AI engine and the address and floor at which the user is located don't match, terminating the transaction.

12. The method of claim 11 wherein the payment device is a credit card.

13. The method of claim 11 wherein the payment device is a mobile device.

14. The method of claim 11 wherein the payment device is a smart watch.

15. The method of claim 11 wherein the first sensor is a gyroscope.

16. The method of claim 11 wherein the second sensor is an altimeter.

17. The method of claim 11 wherein the gyroscopic chip further includes a global positioning system (“GPS”) chip used to identify the location of the payment device.

18. The method of claim 11 wherein the payment device is included in an internet of things (“IoT”) network including a plurality of IoT devices.

19. The method of claim 18 wherein the method further comprises:
identifying a most recently accessed IoT device from the plurality of IoT devices; and
transmitting the fraud alert and location verification message to the most recently accessed IoT device.

20. The method of claim 11 wherein the pre-authentication of the transaction occurs at a point of service (“PoS”) terminal.
